(19) United States
(12) Patent Application Publication
(10) Pub. No.: US 2009/0209189 A1
(43) Pub. Date: Aug. 20, 2009

(54) Air-Conditioning System for Vehicles

(75) Inventors: Ronny Kiel, Leinfelden-Oberaichen (DE); Thorsten Möllert, Stuttgart (DE); Stephanie Larpent, Tokyo (JP)

Correspondence Address: FOLEY AND LARDNER LLP;SUITE 500, 3000 K STREET NW, WASHINGTON, DC, 20007, US

(73) Assignee: BEHR Gmgh & Co. KG

(21) Appl. No.: 10/562,709

(22) PCT Filed: Jun. 18, 2004
(86) PCT No.: PCT/EP04/06635

§ 371 Date: Aug. 25, 2008

(30) Foreign Application Priority Data
Jun. 30, 2003 (DE) 10329582.8
Feb. 20, 2004 (DE) 102004008862.4

(51) Int. Cl. B60H 1/26; B60H 1/02

(52) U.S. Cl. 454/145; 454/161

(57) ABSTRACT

The invention relates to an air-conditioning system comprising a temperature sensing valve. The aim of the invention is to improve air-conditioning systems such that the intermixing of different temperature air currents can be improved by means of an advantageous embodiment of the temperature sensing valve.

The present invention relates to an air-conditioning system for vehicles.

An air-conditioning system for a vehicle is typically composed of a one-part or multipart housing, of a blower for sucking in fresh air or circulation air, of a heat exchanger, in particular an evaporator for cooling the air, of a second heat exchanger for heating the air, of a device for the thermal control of a main air stream and of a mixing space.

A cooled air stream emerging from the evaporator is preferably conducted as a first part air stream into a mixing chamber via a direct duct or cold-air duct and is supplied as a second part air stream, via a further duct, to a further heat exchanger lying downstream of the evaporator and designed as a heating body. The second part air stream conducted via the heating body enters the mixing space as a warmed air stream and, after being mixed with at least part of the first cold part air stream, forms a main air stream.

Starting from the mixing space or the mixing chamber, the main air stream feeds the vehicle interior via various air outlet ports. These air outlet ports or outflow devices, such as, for example defrost-air, middle-air, side-air or footspace-air outflow devices, can be acted upon differently in terms of air quantity via further control flaps.

By means of the different volume flows of cold and warmed part air streams which can be set by means of a device for the thermal control of the air, the temperature of the main air stream or of the air in the mixing chamber is obtained. Such a device for the thermal control of a main air stream which is conducted from the mixing chamber into different regions or else zones of the vehicle interior consists mostly of a temperature mixing flap or of an arrangement of such mixing flaps. By means of different operating positions in such a mixing flap, a directional influencing or control of the action upon various air flow ducts is possible. In particular, volume flow ratios of two differently thermally controlled air streams can be set, in order to achieve a defined temperature after these two or a plurality of air streams have been combined or mixed.

The prior art, for example the patent specification DE 3038272 C2, discloses butterfly flaps, as they may be referred to, for such temperature mixing flaps. These are designed with two wings, are mounted rotatably or pivotably about an axis of rotation and can be moved between two end positions. In this case, the flap or part regions of the flap, in a first end position, completely closes a cold-air duct and simultaneously opens a warm-air duct which guides the air stream toward a heating element. In a second end position, the opposite situation occurs. The flap closes the duct for the heating element completely and only cold air passes into the mixing chamber via a cold-air duct. In intermediate positions of the flap, the cold-air and the warm-air duct are partially closed and opened, so that, depending on the flap position, a specific temperature is set in the mixing chamber in which the two part streams are combined.

When the flap is in a first end position in which, for example, it closes the cold-air duct, said flap is rotated through a small angle in order to achieve a slight lowering of the temperature of the mixed air. At one end region of that wing part of the mixing flap which closes the cold duct, a narrow opening for the passage of cold air into the mixing chamber is released. The disadvantage of this is that, where a butterfly flap is concerned, this opening region lies, as a consequence of design, at that end of the flap which lies on the flap side facing away from the warm-air duct. The cooled air sweeps along the edge region of the cold-air duct past the flap end into the mixing chamber, with the result that only a slight intermixing of warm and cold air is achieved. Outlet ports which are adjacent to this edge region are thus acted upon predominantly by cold air, and ports lying further away are acted upon virtually solely by warm air. This leads, with regard to the air outlet ports from the mixing chamber, to an often undesirable temperature stratification. The same also applies correspondingly to the reverse situation where the initially completely closed warm-air duct is slowly opened.

An improved intermixing of the part air streams is achieved, with a mixing flap of the butterfly type, by spacing apart the axis of rotation or the flap wall in the region of the axis of rotation from an edge region or end of a partition between a cold-air and a warm-air duct, so that, in the positions of the mixing flap which are intermediate to the end positions, a direct passage of the cold air from the cold-air duct into the warm-air duct can take place, thus ensuring a better intermixing of the two part air streams even before entry into the mixing chamber. This arrangement has the disadvantage, however, that, owing to the design of a two-wing flap, overall flap dimensions occur which are determined by the sum of the port widths of the cold-air and warm-air duct. An exemplary version is illustrated in the laid-open publication DE 3510991 A1.

An air-conditioning system with a mixing flap which attempts to remedy this problem is known from the patent specification U.S. Pat. No. 6,231,437 B1. The temperature mixing flap is designed as a drum flap or at least as a drum-like flap. An essential feature of a drum-like flap is that this has a wall which is designed circularly and convexly with respect to the axis of rotation. The overall dimension of the wall region which is provided for closing or opening the ducts is in this case determined only by the maximum port width of the wider of the two ducts. In the embodiment illustrated, the flap is mounted rotatably about an axis of rotation. A closing wall configured in the manner of a segment of a circle is provided with one or more perforations or with regions set back from the closing wall, in order, during pivoting between the “cold” and “warm” end positions, to make it possible to have a direct passage of the cold air from the cold-air duct into the warm-air duct.

Owing to the convexly curved shape of the flap in the flow region of the deflected cold air, an adverse effect on the flow characteristic arises. At specific flap positions, the preferred direction of the entering cold air stream is virtually perpendicular to the closing wall. The cold air impinging onto the wall is swirled even before it flows over into the warm-air duct. The closing wall, which is to ensure a deflection of the cold air, thus forms a flow obstacle. The resulting increased pressure drop is also detrimental to the acoustic properties of the air-conditioning system.

Proceeding from this prior art, therefore, the object of the invention is to provide an improved air-conditioning system which contains a temperature mixing flap having a profile coordinated optimally with the air flow, in particular with the air deflection function.

This object is achieved by means of an air-conditioning system having the features of claim 1. Advantageous refinements are the subject matter of the subclaims.

According to the invention, an air-conditioning system has a blower for generating an air stream. Downstream of this blower is arranged an evaporator. Downstream of the evaporator, the air stream is apportioned by means of a mixing flap to a first flow duct and/or a second flow duct, with the result that a first and/or a second part air stream can be generated. The first flow duct issues into a mixing chamber, while a heat exchanger for warming the second part air stream is arranged in the second flow duct which issues only downstream of the heat exchanger into the mixing chamber.

In the mixing chamber, a mixed or main air stream can be generated from the first and the second part air stream, air outlet ducts leading from the mixing chamber into different regions or zones of the vehicle interior. The air outlet ducts, such as, for example, defrost, middle, side or footspace air ducts, are preferably assigned additional switching flaps which control the air outlet stream from the mixing chamber through the assigned air outlet ducts.

The mixing flap according to the invention for apportioning the air stream consists of at least three sections which are preferably connected to one another in one piece, so that a coherent continuous contour is obtained. This contour forms the wall region of the flap. The mixing flap has an axis of rotation which lies outside this wall region, preferably in the region of the mixing chamber. Of the sections of the flap which form the wall region, two sections extend in the radial direction with respect to the axis of rotation or form an acute angle with this radial direction. At least one further section lies between these two sections and is curved concavely with respect to the axis of rotation. The mixing flap is rotatable or pivotable about its axis of rotation between two end positions. In a first end position, it closes a first flow duct, for example a cold-air duct, completely and opens a second flow duct, for example a warm-air duct. In a second end position, the flap opens the first flow duct (cold-air duct) and closes the second flow duct (warm-air duct) completely. In the positions intermediate to these end positions, a direct passage of cold air into the warm-air duct is possible due to the concave design of one section of the wall region of the flap.

The wall region of the mixing flap is structurally configured such that the concave section forms the essential part, and the sections which adjoin its ends and are radial or designed at an acute angle to the radial direction extend to the edge region of the flap. According to the invention, owing to the concave curvature or vaulting of the wall region, in the flap positions intermediate to the end positions, not only is a direct passage of the cold air into the warm-air duct possible, but a smooth deflection of part of the cold air stream takes place, with swirls before entry into the warm-air duct being avoided as far as possible. Owing to the largely concave shape of the flap, the deflected flow can be conducted such that an opposite direction to that of the warm air stream is obtained in the mixing region in the warm-air duct, and therefore a highly efficient intermixing of the air flows takes place before the warm-air duct issues into the mixing chamber.

In order to optimize the deflection in flow terms and in its acoustic properties, the various sections of the wall region are designed in such a way that they merge continuously one into the other. Depending on the angle at which the cold-air and the warm-air duct are arranged with respect to one another or on the installation position of the heating body, a streamlined adaptation of the concave part of the wall region, for example in the form of an asymmetric profile, can take place.

According to a further advantageous refinement of the air-conditioning system, the mixing flap has a constant contour, in cross section, over the entire length.

If a good intermixing of the cold and warm air streams is to take place only in regions and temperature stratification is to be achieved in regions, the mixing flap may have laterally separated different wall regions, the wall region of the flap in at least one of these regions having the shape according to the invention which is curved concavely with respect to the axis of rotation.

In order to secure the mixing flap in one of its end positions, preferably one or both ends of the wall region are designed in the form of stops. These stop surfaces can come to bear against webs or correspondingly manufactured projecting or set-back regions of the housing wall and, in an end position, ensure that a flow duct is sealed off. Preferably, the stop surfaces are coated with a sealing material, for example an injection-molded foam surround.

That section of the wall region of the mixing flap which is concave with respect to the axis of rotation may be designed circularly or in the form of a segment of a circle. Further possibilities for the profile of the flap are elliptic, parabolic, hyperbolic or any desired continuously concavely curved shapes, and the concave section may also be composed of combinations of these said profiles. In the limiting case, a concavely curved section of the mixing flap may even be designed rectilinearly, with the result that an air-conditioning system according to the invention can likewise be implemented. If the concave section of the flap is divided into a plurality of subsections, portions may also run straight, as long as the overall structure preserves an essentially concave shape.

For the articulation of the mixing flap, preferably, pivoting arms arranged at the edge on the axis of rotation are used, which, starting from the axis of rotation, widen in the form of a segment of a circle. For stiffening, one or more pivoting arms may also be arranged along the longitudinal axis of the flap.

Moreover, the invention is explained in more detail below with reference to the exemplary embodiments illustrated in the drawings in which:

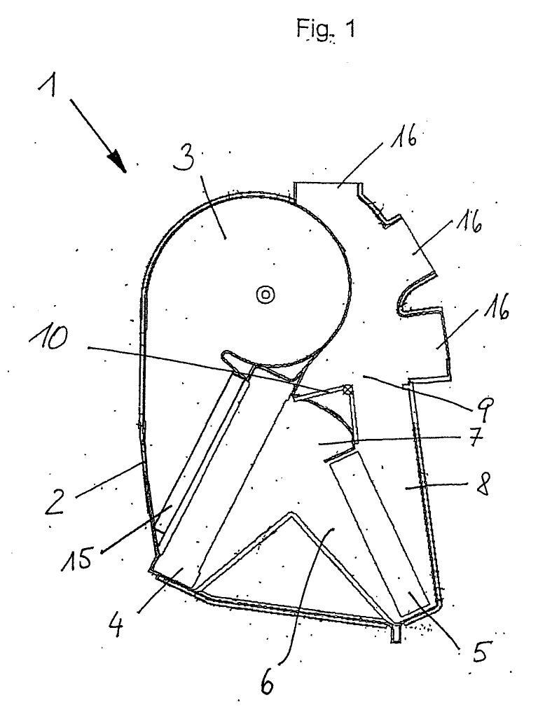

FIG. 1 shows a cross-sectional illustration through an air-conditioning system according to the invention with a temperature mixing flap which completely closes the cold-air duct—“warm” position; and

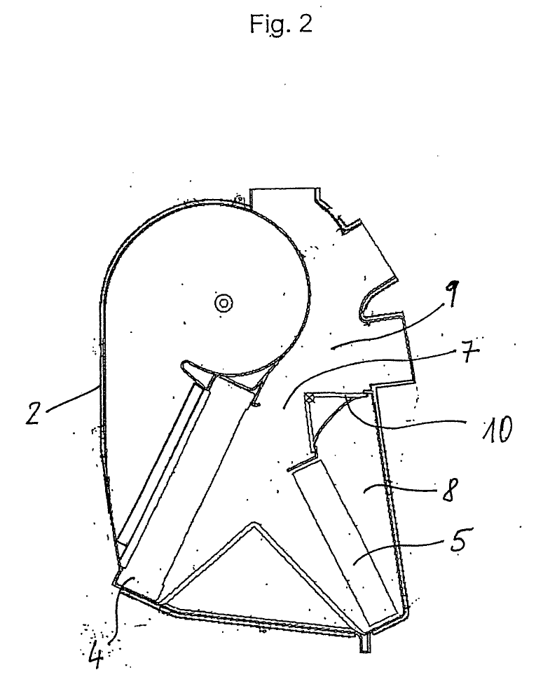

FIG. 2 shows a cross-sectional illustration through an air-conditioning system according to the invention with a temperature mixing flap which completely closes the warm-air duct—“cold” position; and

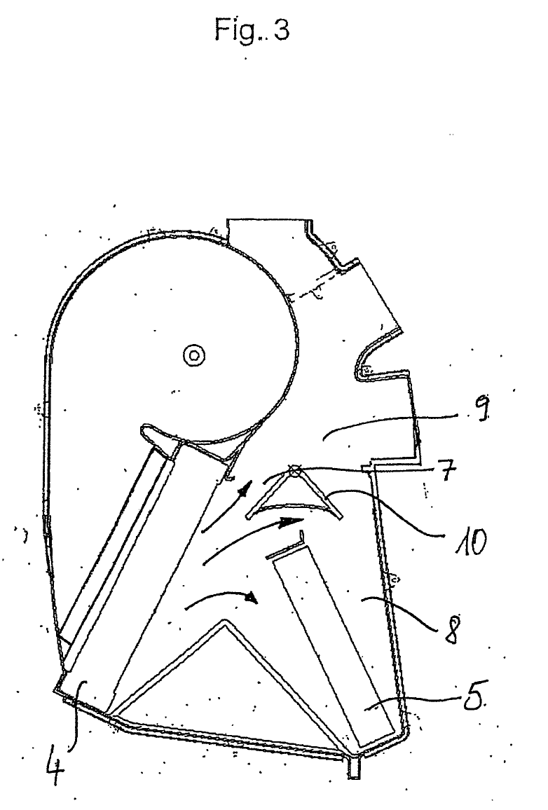

FIG. 3 shows a cross-sectional illustration through an air-conditioning system according to the invention with a temperature mixing flap which, in an intermediate position, partially closes the fresh-air and the warm-air duct; and

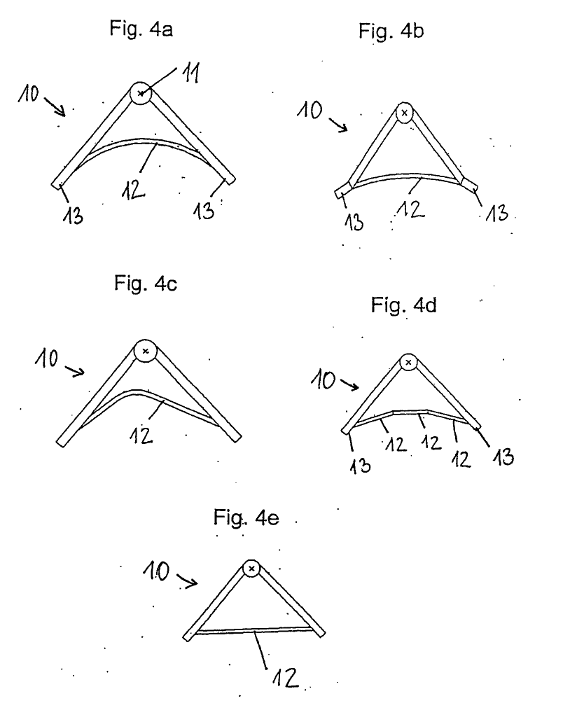

FIG. 4a-4e show cross-sectional illustrations of exemplary embodiments of a temperature mixing flap; and

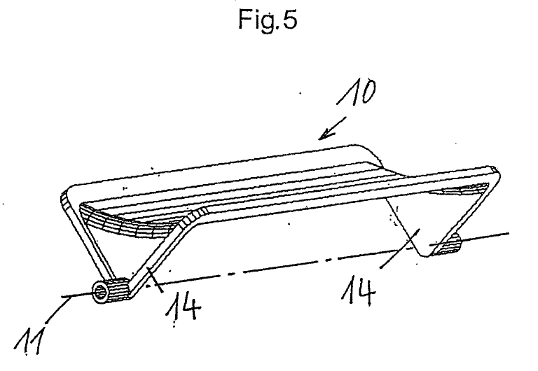

FIG. 5 shows a diagrammatic perspective illustration of a temperature mixing flap with pivoting arms and a pivot axis; and

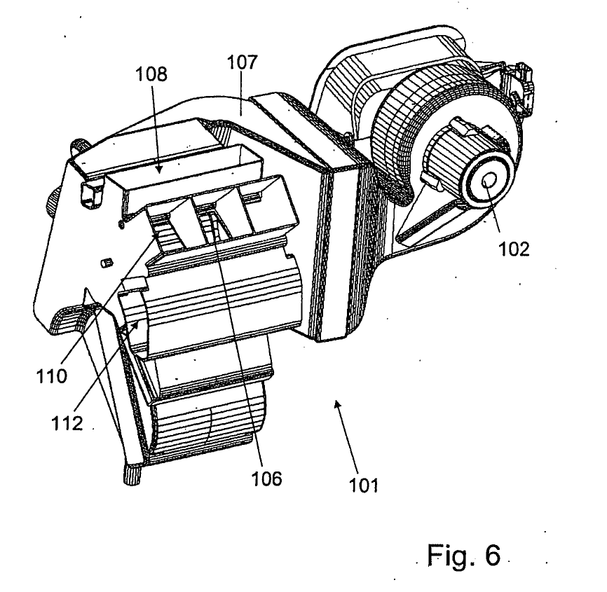

FIG. 6 shows a perspective view of an air guidance housing; and

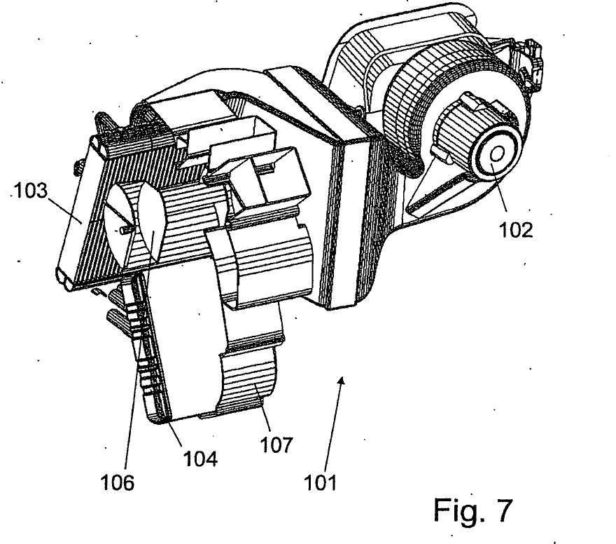

FIG. 7 shows the air guidance housing of FIG. 6, cut away in regions, from the same perspective; and

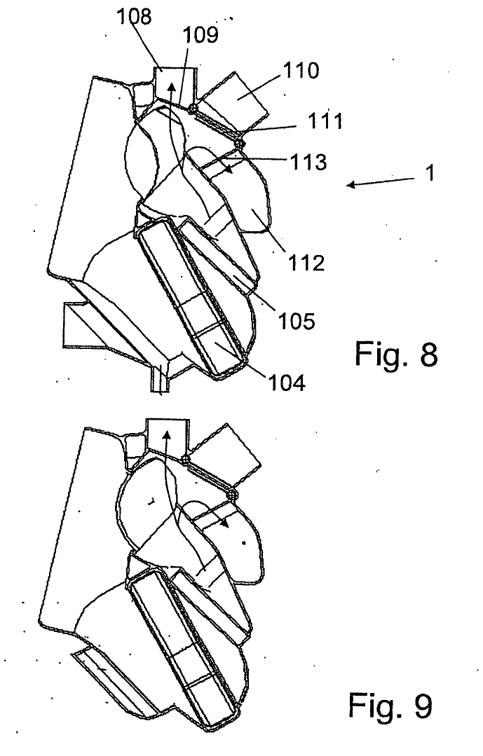

FIG. 8 shows a section through the air guidance housing in the middle of the flap in the 100% warm flap position; and

FIG. 9 shows a section through the air guidance housing in the lateral region of the flap in the flap position of FIG. 8; and

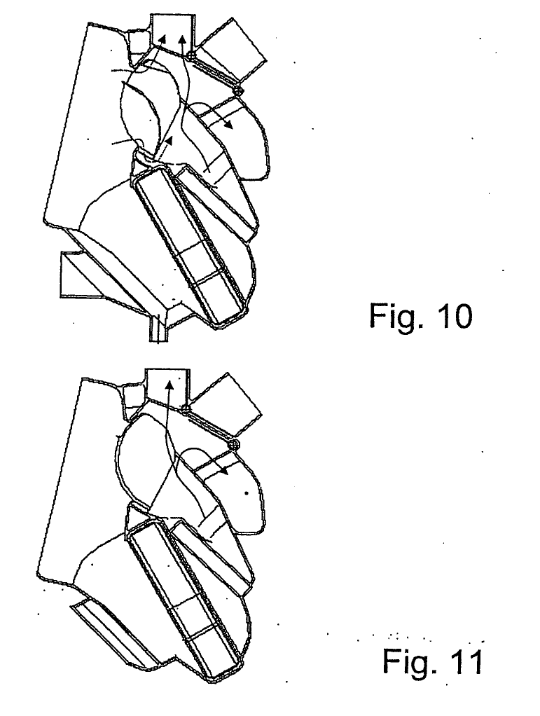

FIG. 10 shows a section through the air guidance housing in the middle of the flap in the 75% warm flap position; and

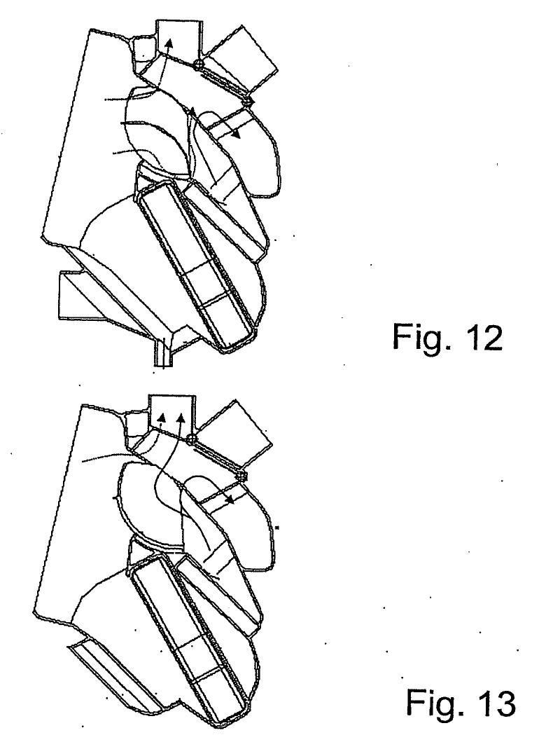

FIG. 11 shows a section through the air guidance housing in the lateral region of the flap in the flap position of FIG. 10; and

FIG. 12 shows a section through the air guidance housing in the middle of the flap in the 50% warm flap position; and

FIG. 13 shows a section through the air guidance housing in the lateral region of the flap in the flap position of FIG. 12; and

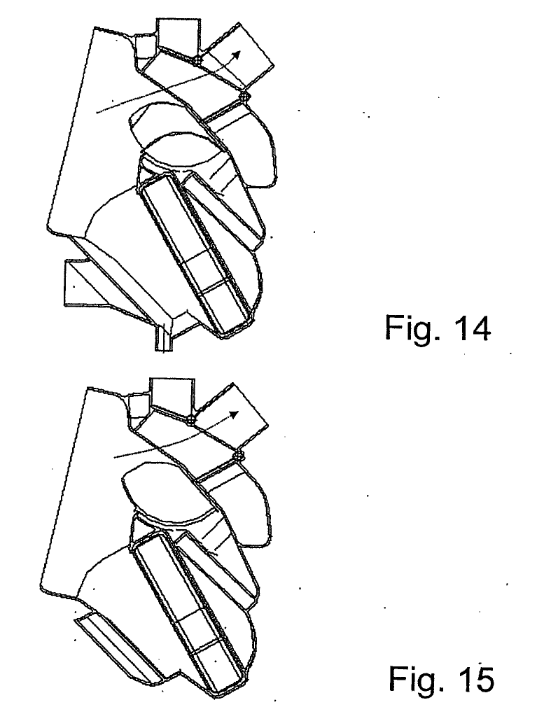

FIG. 14 shows a section through the air guidance housing in the middle of the flap in the 0% warm flap position; and

FIG. 15 shows a section through the air guidance housing in the lateral region of the flap in the flap position of FIG. 14; and

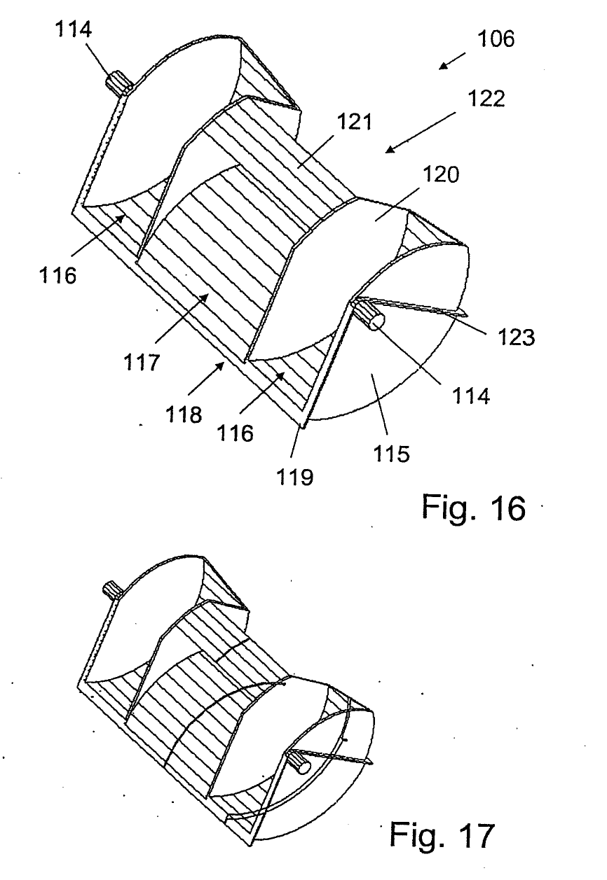

FIG. 16 shows a perspective view of the flap; and

FIG. 17 shows the view of FIG. 16 with an illustration of the sectional lines of FIGS. 8 to 15; and

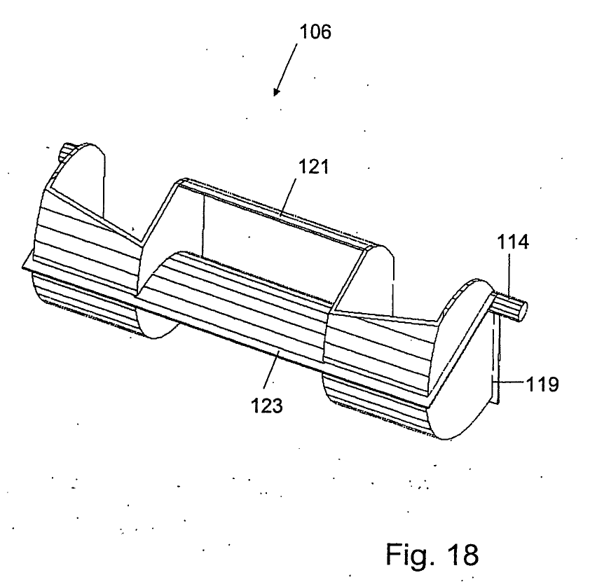

FIG. 18 shows the flap from another perspective; and

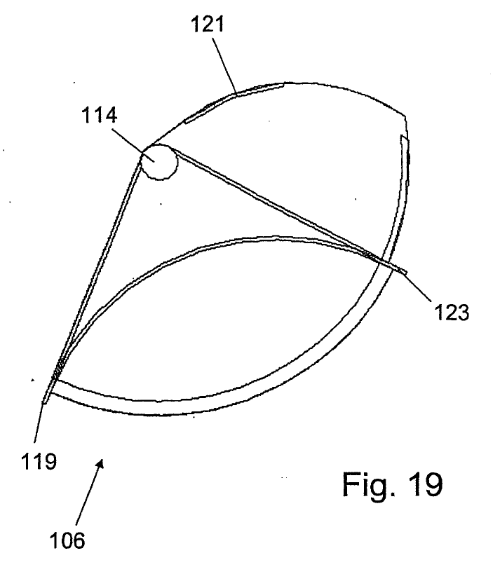

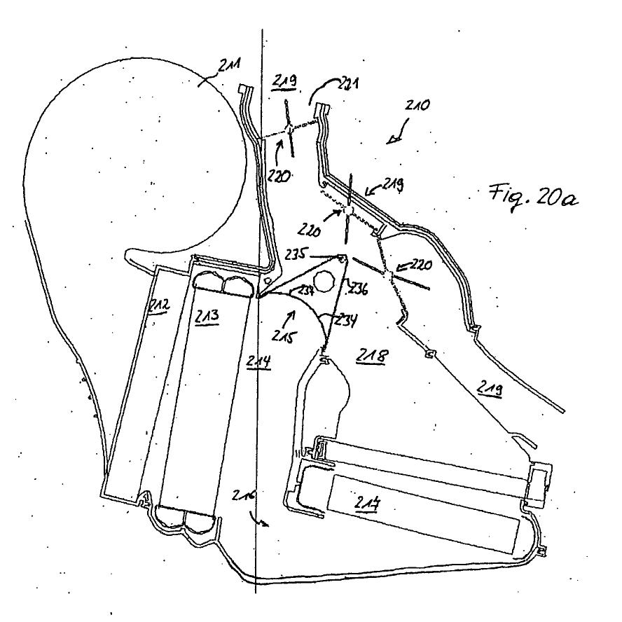

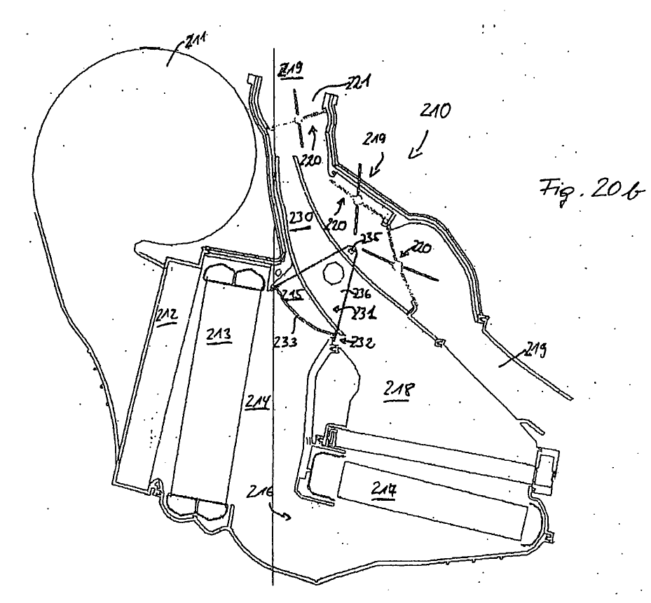

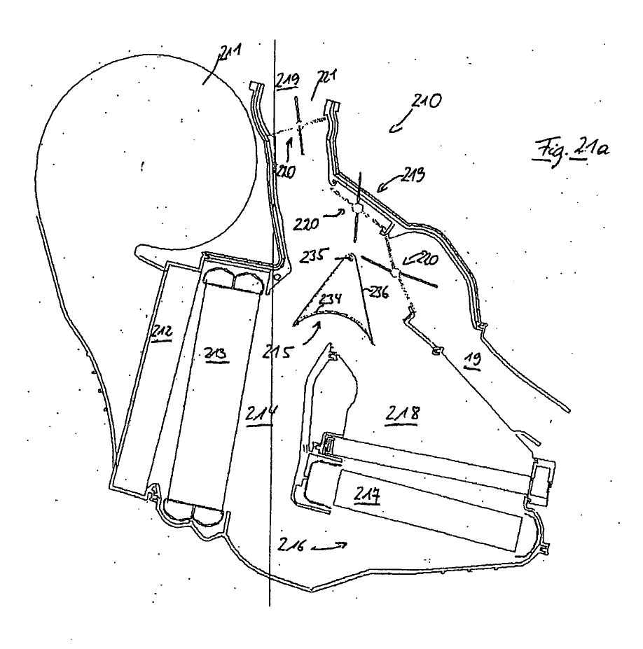

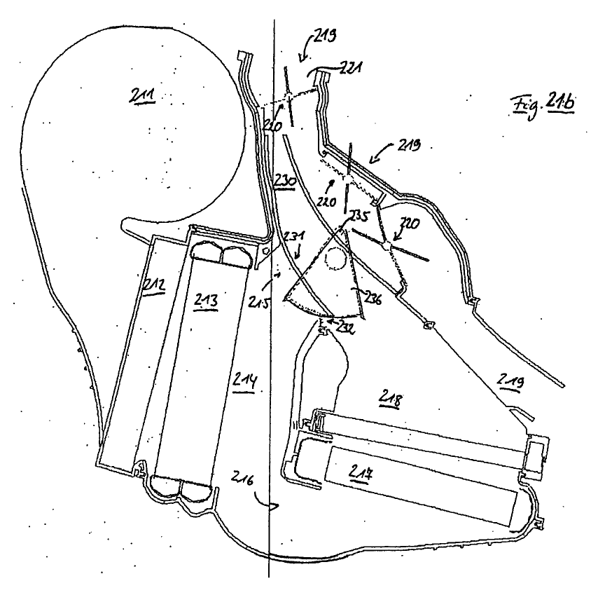

FIG. 19 shows a cross section through the flap; and

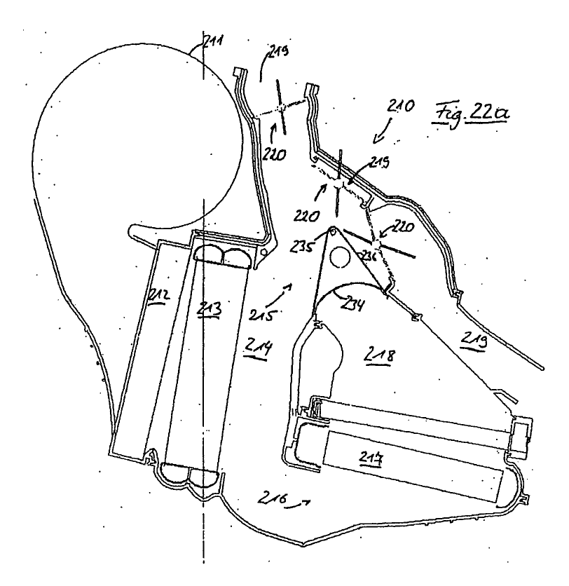

FIG. 20a, 20b show cross-sectional illustrations through an air-conditioning system according to the invention respectively in the region next to a bypass duct and in the region of the bypass duct, with the first flow duct closed by control flaps; and

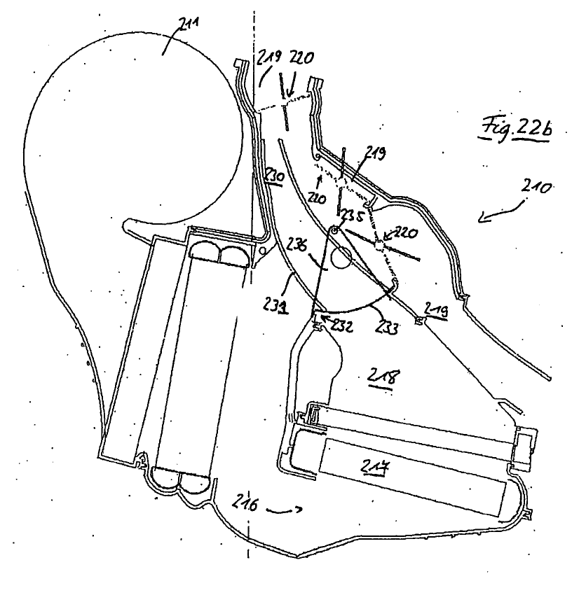

FIG. 21a, 21b show cross-sectional illustrations through an air-conditioning system according to the invention respectively in the region next to a bypass duct and in the region of the bypass duct, with the first flow duct partly opened by control flaps; and

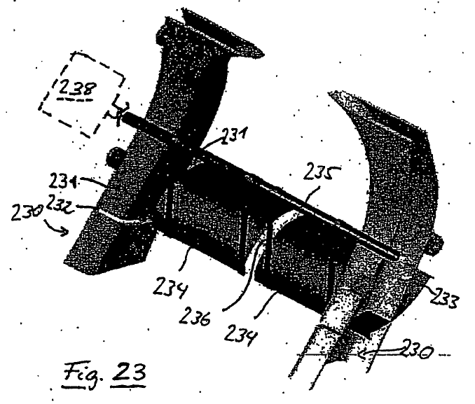

FIG. 22a, 22b show cross-sectional illustrations through an air-conditioning system according to the invention respectively in the region next to a bypass duct and in the region of the bypass duct, with the second flow duct closed by control flaps; and

FIG. 23 shows a diagrammatic perspective illustration of a flap element, which comprises both a mixing flap and a control flap, and also the associated bypass ducts.

FIGS. 1, 2 and 3 show an air-conditioning system 1 according to the invention in a cross-sectional illustration. Within the blower housing 3 is arranged a blower, not illustrated, preferably a radial fan, which sucks in air perpendicularly with respect to the sectional plane. The air conveyed by the radial fan flows first through an air filter 15 and then through the evaporator 4 in which the air is cooled.

The evaporator 4 is followed downstream by a flow duct 7, which is designated as a cold-air duct, and by a further flow duct 6, which is designated as a heating body inlet duct. The air flowing into the flow duct 6 passes, downstream of the evaporator 4, through a heat exchanger 5 which is designed as a heating body. An optional additional heater, such as, for example, a PTC heater, is not illustrated. Via the flow duct 8, which is designated as a warm-air duct and is located downstream of the heating body, warmed air passes into the mixing chamber 9, into which the cold-air duct 7 also issues.

FIGS. 1, 2 and 3 show the mixing flap 10 in a first end position, in a second end position and in an intermediate position. The setting of the mixing flap 10 determines the ratio between the open flow cross section of a first flow duct 7 to a second flow duct 8 and therefore the fraction of the volume flow which comes from the evaporator 4 and is not guided via the heat exchanger 5. The temperature of the resulting mixed air set in the mixing chamber 9 is consequently controlled or regulated.

A plurality of air outlet ducts 16 emanates from the mixing chamber 9, each of these ducts being assigned one or more switching flaps (not illustrated in the figures), by means of which the size of the air stream in the corresponding air outlet ducts 16 can be controlled or regulated.

In FIG. 1, the mixing flap 10 is illustrated in a first end position, said mixing flap closing the passage of the air stream through the cold-air duct 7. The entire air stream emerging from the evaporator 4 is conducted via the flow duct 6 to the heat exchanger 5 and further on, via the warm-air duct 8, into the mixing chamber 9. A radial section 13 of the mixing flap 10 sealingly bears, adjacently to the upper end of the evaporator 4, against a projecting region of the housing 2. A second radial section 13 of the mixing flap 10 bears against a web of a housing 2 in the region of the upper end of the heat exchanger 5. A corresponding coating of the ends of the radial sections 13 ensures an as far as possible airtight closure of the cold-air duct 7.

FIG. 2 shows the mixing flap 10 in a second end position, said mixing flap closing the passage of the air stream through the warm-air duct 8. The entire air stream emerging from the evaporator 4 is conducted via the cold-air duct 7 into the mixing chamber 9. A radial section 13 of the mixing flap 10 sealingly bears, adjacently to the upper end of the heat exchanger 5, against a projecting region of the housing 2. A second radial section 13 of the mixing flap 10 bears sealingly against a web of the housing 2 at the right edge of the warm-air duct 8.

The mixing flap 10 is illustrated in an intermediate position in FIG. 3. Neither the cold-air duct 7 nor the warm-air duct 8 are completely closed or opened. The flow path of the air stream coming from the evaporator 4 is indicated by the depicted arrows. The cold air stream is in this case divided into a first part stream, which passes directly into the mixing chamber 9, and a second part stream, which is deflected via the wall region of the mixing flap 10 into the warm-air duct 8, where it is intermixed with the part air stream which has passed through the heat exchanger 5. As is evident from FIG. 3, a smooth deflection of the cold part stream is possible due to the streamlined shape of the radial sections 13 and, in particular, of the concave section 12.

FIGS. 4a to 4e illustrate exemplary embodiments of a mixing flap 10 in cross-sectional views.

FIG. 4a shows the wall region, composed of the sections 13 and 12, of the mixing flap 10. The end sections 13 run in the radial direction, starting from the axis of rotation 11. The middle section 12 has a concave curvature with respect to the axis of rotation 11. To improve the flow properties of the mixing flap 10, the radial sections 13 merge continuously into the concave section 12. The radial sections 13 serve as a stop on the housing, in order to secure the mixing flap 10 in its end positions. In order to ensure that the flow ducts 7 and 8 are sealed off in the end positions, the stop surfaces of the mixing flap 10 are coated with a sealing material, for example an injection-molded foam surround.

In FIG. 4b, the sections 13, although straight, have a slight deviation from the radial direction. This is advantageous particularly for a mixing flap 10 which contains a concave section 12 with a slightly curved profile, in order to fulfill the requirements of continuity at the connecting regions between the sections 13 and 12.

In order, during the opening or the closing movement of the mixing flap 10, to achieve a controlled variation, adapted to the respective requirements for the desired mix ratio of warm and cold air, of the cross-sectional area for the direct passage of the cold air flow into the warm-air duct 8, the concave wall section 12 may also have an asymmetric profile, as shown in FIG. 4c.

An approximation to as far as possible concave curvature profile is also achieved by lining up straight sections 12 with one another, as illustrated by way of example in FIG. 4d. In the limiting case, this results in the shape of a triangular flap with a straight section 12, as illustrated in FIG. 4e.

FIG. 5 shows a perspective illustration of a mixing flap 10 with pivoting arms 14 attached laterally to the end faces of the flap 10, the pivoting arms 14 widening radially and being designed in the form of webs which extend from the axis of rotation 11 of the mixing flap 10 toward the wall region.

A motor vehicle air-conditioning system 101 with a mixing flap 106 which has, only in a part region, a wall region 117 according to the invention, which is concave with respect to the axis of rotation, is described in FIG. 6 to 19.

This motor vehicle air-conditioning system 101 with a blower 102, with an evaporator 103, with a heater 104 and with an additional heater 105, which are arranged in an air guidance housing 107 of multipart design, has a mixing flap 106 for the on-demand thermal control and generation of a stratified air flow.

The thermally controlled air can be supplied to various regions of the vehicle interior via air ducts regulated by means of flaps. Thus, an air duct 108 is provided which branches off from the air guidance housing 107 and which serves for defrosting the windshield. The air quantity guided through the defrost air duct 108 is regulated by means of a defrost flap 109. A further air duct 110 leads to side and middle nozzles and can be regulated by means of a flap 111. Furthermore, a footspace air duct 112 is provided, which can be regulated by means of a footspace flap 113.

As is evident from FIG. 6, the ventilation air duct 110 is designed in three parts, in the present case the three subducts in each case having approximately the same cross section. They serve, in cooperation with the flap 106, for air stratification between the middle and side nozzles.

In order to make this air stratification possible by means of a single flap which makes it unnecessary to have partitions or specially designed cold-air ducts and therefore has a somewhat lower construction space requirement, the flap 106, which is in three parts according to the present exemplary embodiment, is provided. This has, in its pivot axis, two tenons 114 which are arranged on the end faces 115. The flap 106 is designed mirror-symmetrically with respect to a plane running perpendicularly with respect to the pivot axis in the middle of the flap 106, the section lines of this plane together with the flap 106 being illustrated in FIG. 17.

The flap 106, by virtue of its symmetry, has two outer regions 116 and one middle region 117. It is designed in the manner of a drum flap in its outer regions 116, that is to say the flap 106 has the configuration of part of a hollow cylinder. On a side 118 extending in the longitudinal direction of the flap 106, the regions 116 and 117 terminate to the same height, there being provided, for better sealing off, an edge 119 which extends radially outward and which also extends beyond the end faces 115 as far as the tenons 114. According to the present exemplary embodiment, the flow cross section of the two outer regions 116 together corresponds approximately to the flow cross section of the middle region 117.

The middle region 117 is designed to be vaulted in the direction of the pivot axis and is separated from the lateral regions 116 by walls 120. At the end of the walls 120 which is on the pivot-axis side, these are connected by means of a bridge 121, the latter being vaulted slightly according to the middle region 117. This bridge 121 serves, on the one hand, as a kind of spoiler with an air guide function and, on the other hand, for increasing the stability of the flap 106.

On that side 122 of the flap 106 which lies opposite the side 118, the regions 116 and 117 terminate at different heights, as is evident particularly from FIG. 18. To improve the opening behavior, the outer regions 116 are designed to be beveled, that is to say, in particular, they do not run parallel with respect to the pivot axis. The middle region 117 terminates parallel with respect to the pivot axis, again an edge 123 being provided which extends outward and which also extends beyond the outside of the outer regions 116 and the end faces 115 as far as the tenons 114 and therefore as far as the edge 119.

The functioning of the flap 106 is explained in more detail below with reference to FIGS. 8 to 15.

FIGS. 8 and 9 show the 100% warm position, that is to say the flap 106, with all the regions 116 and 117, closes the path for the cold air coming directly from the evaporator 103. In this case, the flap 106 bears with its edge 119 against the correspondingly designed air guidance housing 107, so that no cold air can arrive at the air ducts 108 and 112. The flow path of the warm air coming from the heater 104 and additional heater 105 is illustrated by means of unbroken arrows for the situation with opened defrost and footspace flaps 109 and 113. The flap 111 for the supply of air to the side and middle nozzles is closed according to the illustration.

When the flap 106 is moved slowly into its other end position, as illustrated in FIGS. 10 and 11, a cold-air passage, through which cold air flows, in particular, into the defrost air duct 108, is released on both sides in the middle region 117 of the flap 106. What is achieved thereby is that the temperature of the air which is conducted into the footspace is higher than the temperature of the air which enters the defrost air duct 108. Since the outer regions 116 are designed to be wider, the cold-air passage is still closed in these regions. The flow path of the cold air is illustrated in the drawing by means of dotted arrows.

In the event of a further movement of the flap 106, as illustrated in FIGS. 12 and 13, the cold-air passage in the middle region 117 is opened increasingly more widely, so that the temperature falls further. In the outer regions 116, the cold-air passages begin to open slowly on account of the bevel, and cold air arrives in the outer regions 116, in particular to the defrost air duct 108. Here, too, temperature stratification giving the passenger a pleasant feeling is achieved, in that the temperature of the air which is conducted into the footspace is higher than the temperature of the air which enters the defrost air duct 108.

In flap positions which cause an opening or at least partial opening of the air duct 110 (not illustrated in FIGS. 8 to 13), temperature stratification between middle and side air ducts is obtained owing to the described shape of the flap 106, the temperature of the air which is supplied to the middle nozzle or middle nozzles is lower than the air temperature in the side nozzles, thus likewise contributing to an increase in comfort in the interior, since the radiation of heat via the side windows is greater than in the middle of the passenger space, and the temperature stratification described results in an equalization of, at least, the temperature profile which the passenger feels.

When the warm-air passage is closed completely, as in FIGS. 14 and 15, cold air arrives at the corresponding air ducts 108, 110 and 112 in all the regions 116 and 117. In the exemplary embodiment illustrated, in this case, both the defrost air duct 109 and the air duct 112 into the footspace are closed, and only uniformly cold air passes into the ducts 110 for the side and middle nozzles.

A stratification of the air can thus become possible, in all the mixed or intermediate positions of the flap 6, the air supplied to the windshield being colder than the air supplied to the footspace or the air supplied to the middle nozzles being colder than the air supplied to the side nozzles.

In order to achieve a correspondingly desired temperature stratification, in a further exemplary embodiment, a three-part mixing flap is provided, in which the two outer regions are curved convexly and are guided in a bypass duct. The region lying between them has a curvature according to the invention of the wall region which is concave with respect to the axis of rotation. This exemplary embodiment is explained in more detail below with reference to FIGS. 20 to 23. The two outer regions of the flap are referred to below as the mixing flap and the inner region as a switching flap.

The three pairs of figures of FIGS. 20a, 20b; 21a, 21b; 22a, 22b show in each case a sectional illustration through an air-conditioning system according to the invention. The figures designated by a always show in this case a section through the region outside a bypass duct, whereas the figures designated by b show the section in the region of the bypass duct, the flap positions of identical pairs of figures corresponding to one another. The position of the bypass duct in the air-conditioning system is selectable. More than one bypass duct may also be provided, each bypass duct then having a mixing flap. The bypass duct may in this case be formed, in particular, on one side or on both sides laterally on the air-conditioning system or else centrally.

The pairs of FIGS. 20 to 22 show an air-conditioning system 210 in a cross-sectional illustration. Within the blower housing 211 is arranged a blower, not illustrated, a radial fan, which sucks in air perpendicularly with respect to the sectional plane.

The air conveyed by the radial fan flows first through the air filter 212 and then through the evaporator 213 in which the air is cooled. The evaporator 213 is followed downstream by the distributor space 214. In the regions in which a bypass duct 230 extends, a wall 231 of the bypass duct 220 closes the first flow duct 215, with the exception of a slit 232, through which the mixing flap 233 is guided, in which case guidance may be fluid-tight in order to avoid leakage flows. In the regions next to the bypass duct, the first flow duct 215 leads directly into the mixing chamber 218.

The second flow duct 216 leads from the distributor space 214 into the mixing chamber 218 via the heat exchanger 217. The switching flap 234, shown in different positions, the two end positions and an intermediate position, in the three pairs of figures, determines, by means of its position, the ratio between the open flow cross section of the first flow duct 215 and of the second flow duct 216 and therefore the fraction of the volume flow coming from the evaporator 213 and not guided via the heat exchanger 217. The temperature of the resulting mixed air which is set in the mixing chamber 218 is consequently controlled or regulated.

A plurality of air outlet ducts 219 lead away from the mixing chamber 218, each of these ducts being assigned a switching flap 220 by means of which the size of the air stream into the corresponding air outlet duct 219 can be controlled or regulated. To achieve temperature stratification in the vehicle, the air outlet ducts 219 branch off at points with a different mix ratio between air from the first and from the second flow duct 215 and 216, so that different temperatures of the mixed streams are obtained.

One of the air outlet ducts is what is known as the defrost duct 221. This leads to defrost nozzles which are arranged directly in the region of a window, in particular the front window of a vehicle, and serves for the rapid heating of the window or for freeing the window of misting due to condensing water vapor. In this case, the defrost duct 221 branches of at a point which has a high fraction of air from the first flow duct and is therefore relatively cool. This impedes the heating and mist avoidance function, but is also as a consequence of design. The bypass duct 230 is therefore provided, which branches off in the second flow duct 216 and issues in the defrost duct 221 directly upstream of the corresponding switching flap 221. An increased warm-air fraction is thereby supplied to the air stream in the defrost duct 221. The volume flow through the defrost duct 221 is in this case variable via the position of the mixing flap 233, because the free flow cross section is dependent on the mixing flap position. The switching flap 220 assigned to the defrost duct 221 in this case controls the size of the volume flow through the defrost duct 221, but not the fraction of the volume flow from the bypass duct 230 therein.

In this case, in the embodiment illustrated, the mixing flap 233 and the switching flap 234 are arranged on a common pivot axis 235, the flaps having vaulted surfaces 237 and being brought to bear against the pivot axis 235 via radially widening pivoting arms 236. The pivoting arms 236 in this case have at least one partially closed side surface which has a separating function between the bypass duct 230 and first flow duct 215. The position of the mixing flap 233 is thus coupled directly to the position of the switching flap 234, and these can be varied in position together as a result of the rotation of the pivot axis with respect to the housing by means of an actuator 238, as shown in FIGS. 20 to 22.

If, as shown in FIGS. 20a and 20b, the first flow duct 215 is closed, the entire air flow is guided via the heat exchanger 217 and is warmed there. The bypass duct 230 is then opened at a maximum, and a high volume flow fraction of warm air is supplied to the defrost duct 221. This leads to a relatively high air temperature in the defrost duct 221 and to as rapid as possible a warming of the assigned window pane or front window and therefore to a mist-free and ice-free window.

If, as shown in FIGS. 22a and 22b, the first flow duct 215 is opened, the entire air flow is guided via the first flow duct 215 and therefore past the heat exchanger 217. The bypass duct 230 is then closed and no warmed air from the bypass duct 230 is supplied to the defrost duct 221. This leads to a relatively low air temperature in the defrost duct 221, and a rapid cooling of the interior and the generation of a favorable air stratification in the vehicle interior are promoted.

In the intermediate position illustrated in FIGS. 21a and 21b, in each case part streams are generated. Consequently, via the bypass duct 230, a small warm-air volume flow is guided to the defrost duct 221, and this has, as compared with the air otherwise flowing through it, an increased temperature, where the latter is not increased as sharply as if the air were capable of flowing freely through the bypass duct. As a result, in the region of the window assigned to the defrost duct 221, a warmed air is supplied, which nevertheless does not disturb the temperature stratification in the vehicle to a needlessly great extent. The degree of warming is influenced by the degree of the desired temperature change from which the position of the switching flap 234 is determined.

FIG. 23 shows a perspective illustration of a flap element which combines a mixing flap 233 and a switching flap 234. In this case, the mixing flap segment 233 is vaulted convexly, while the switching flap segment 234 is vaulted concavely. The elliptic lens between the switching flap segment 234 and the mixing flap segment 233 forms a wall 231 which also ensures fluidic separation between the bypass duct 230 and the first flow duct 215 in this region in which the slit 231 also runs in the bypass duct 230. In this case, this wall may also be part of a pivoting arm 236 widening radially outward. In the embodiment illustrated, however, the pivoting arms 236 are designed as webs formed separately from this. FIG. 23 in this case shows two laterally arranged bypass ducts 231 which each have a mixing flap 233, the first flow duct 216 extending between them and being closable by means of two switching flaps 234 arranged in it. In this case, the actuator 238, which is responsible for generating the actuating movement of the flaps, is indicated by dashes in this figure. The actuator 238 is in this case activated by a corresponding control unit by means of which the methods according to the invention are also carried out.

1. An air-conditioning system for vehicles,
with a blower for generating an air stream,
with an evaporator which is arranged downstream of the blower and through which the air stream flows,
with a mixing flap following the evaporator,
the air stream being apportionable by means of the mixing flap to a first flow duct and/or a second flow duct, with the result that a first and/or a second part air stream can be generated,
the first flow duct (cold-air duct) issuing into a mixing chamber,
while a heat exchanger for warming the second part air stream is arranged in the second flow duct (warm-air duct) and the second flow duct issues, downstream of the heat exchanger, into the mixing chamber,
a mixed air stream being capable of being generated from the first and the second part air stream in the mixing chamber, air outlet ducts leading from the mixing chamber into different regions of the vehicle interior,
and the mixing flap being pivotable about an axis of rotation between a first end position, in which it completely closes the first flow duct, and a second end position, in which it completely closes the second flow duct, and, in the intermediate positions, allowing a direct passage of cold air from the first flow duct into the second flow duct,
wherein
the mixing flap for apportioning the air stream consists of at least three sections and the axis of rotation lies outside these sections, a first section being arranged in the radial direction or at least at an acute angle to the radial direction with respect to the axis of rotation, a second section being arranged concavely with respect to the axis of rotation, and a third section being arranged in the radial direction or at least at an acute angle to the radial direction with respect to the axis of rotation, in such a way that the first and the third section adjoin opposite ends of the second section so that the three sections form a wall region with a continuous contour.

2. The air-conditioning system as claimed in claim 1, wherein the mixing flap has, in cross section with respect to the axial direction, a contour which is constant over the entire length of the mixing flap.

3. The air-conditioning system as claimed in claim 1, wherein the sections of the wall region of the mixing flap merge continuously one into the other.

4. The air-conditioning system as claimed in claim 1, wherein the air-conditioning system has a mixing flap with a wall region, one end of a section of the wall region forming a stop.

5. The air-conditioning system as claimed in claim 1, wherein the air-conditioning system has a mixing flap with a wall region, two opposite ends of two sections of the wall region in each case forming a stop.

6. The air-conditioning system as claimed in claim 1, wherein the air-conditioning system has a mixing flap with a wall region, one section or two sections of the wall region having sealing regions in the region of the stop surfaces.

7. The air-conditioning system as claimed in claim 1, wherein the mixing flap has a wall region which is continuous in its entire surface.

8. The air-conditioning system as claimed in claim 1, wherein the wall region of the mixing flap is designed at least partially circularly or in the form of a segment of a circle.

9. The air-conditioning system as claimed in claim 1, wherein the wall region of the mixing flap is designed at least partially in an elliptic, parabolic, hyperbolic or another continuously curved shape.

10. The air-conditioning system as claimed in claim 1, wherein the mixing flap is articulated on the pivot axis via pivoting arms which widen in the form of a segment of a circle and are preferably also arranged at the edge.
